(19) United States
(12) Patent Application Publication
(10) Pub. No.: US 2021/0386071 A1
(43) Pub. Date: Dec. 16, 2021

(54) ANTI-NON-ENVELOPED VIRUS AGENT AND COMPOSITION CONTAINING SAME, AND ANTI-VIRAL PRODUCT AND METHOD FOR PRODUCING SAME

(71) Applicant: TOAGOSEI CO., LTD., Minato-ku (JP)

(72) Inventors: Megumi NIWA, Nagoya-shi (JP); Yoshinao YAMADA, Nagoya-shi (JP)

(73) Assignee: TOAGOSEI CO., LTD., Minato-ku (JP)

(21) Appl. No.: 17/289,497

(22) PCT Filed: Oct. 31, 2019
(86) PCT No.: PCT/JP2019/042926

§ 371 Date: Apr. 28, 2021

(30) Foreign Application Priority Data
Dec. 27, 2018 (JP) 2018-246041

(51) Int. Cl. A01N 59/00; C09D 5/14; C09D 7/61; A01N 59/06; D06M 11/44; D06M 11/79; D06M 11/45; D06M 15/263

(52) U.S. Cl. CPC A01N 59/00; C09D 5/14; C09D 7/61; D06M 15/263; D06M 11/44; D06M 11/79; D06M 11/45; A01N 59/06

(57) ABSTRACT

An object of the present invention is to provide an antiviral agent suitable for inactivating a non-enveloped virus, a composition containing thereof, an antiviral product, and a method for producing the same. The antiviral agent against a non-enveloped virus includes at least one selected from a group consisting of (A) a compound containing Al element, Mg element, and O element; (B) a compound containing an alkali metal element or an alkaline earth metal element, Si element, and O element; and (C) a hydroxide containing a divalent metal element.

### TECHNICAL FIELD

The present invention relates to an antiviral agent suitable for inactivating a non-enveloped virus, a composition containing thereof, an antiviral product, and a method for producing the same.

### BACKGROUND ART

Viral diseases caused by influenza virus, norovirus, etc. have become a big problem all over the world, and a high level of hygiene awareness has been gained in daily life.

Viruses are structurally generally divided into two types according to the presence or absence of an envelope. The influenza virus is an enveloped virus with an envelope, and the norovirus is a non-enveloped virus without an envelope.

Conventionally, in order to inactivate a virus, a method of killing the virus by heat treatment, treatment with an organic solvent such as ethanol, treatment with a surfactant, or the like is generally known. These methods are known as inactivation treatments that are particularly effective against an enveloped virus. However, the non-enveloped virus has resistance to the above-mentioned treatment, and the same effect as that on the enveloped virus cannot be expected.

Thus, development of an antiviral agent that inactivates the non-enveloped virus has been actively promoted in recent years.

Patent Literature 1 discloses a complex containing a fiber and a hydrotalcite, represented by [M²⁺₁₋ₓM³⁺ₓ(OH)₂][Aⁿ⁻_{x/n}·mH₂O] (in the formula, M^{2 +} represents a divalent metal ion, M³⁺ represents a trivalent metal ion, and Aⁿ⁻_{x/n} represents an interlayer anion, 0<x<1 is defined, n is the valence number of A, and 0≤m<1 is defined), and a process for preparing the complex and describes that the complex has low antiviral properties, so that the performance is improved when the complex is treated with a copper thiosulfato solution.

Patent Literature 2 discloses an antiviral film that includes a silicon-containing compound (siloxane compound, etc.) and having a film surface pH of 6 or less.

Patent Literature 3 discloses an antiviral composition that includes silver and a polyalkylene biguanide compound having a specific structure and/or a salt thereof.

### PRIOR TECHNICAL ART

### Patent Literature

Patent Literature 1: WO 2018/30521

Patent Literature 2: WO 2017/86098

Patent Literature 3: JP 2015-78132 A

### SUMMARY OF INVENTION

### Technical Problems

An object of the present invention is to provide an antiviral agent suitable for inactivating a non-enveloped virus, a composition containing thereof, an antiviral product, and a method for producing the same.

### Solutions to Problems

The present invention is as follows.

[1] An antiviral agent against a non-enveloped virus, including at least one selected from a group consisting of:

(A) a compound containing Al element, Mg element, and O element;

(B) a compound containing an alkali metal element or an alkaline earth metal element, Si element, and O element; and

(C) a hydroxide containing a divalent metal element.

[2] The antiviral agent against a non-enveloped virus according to [1] above, wherein the compound (A) is a compound represented by a following formula (1).

MgₓAl_{y}O_{(x+1.5y)} (1)

(In the formula, x and y are integers.)
[3] The antiviral agent against a non-enveloped virus according to [1] or [2] above, wherein the compound (B) is a silicate.
[4] The antiviral agent against a non-enveloped virus according to any one of [1] to [3] above, wherein the hydroxide (C) is a compound containing an alkaline earth metal element.
[5] An antiviral product including the antiviral agent against a non-enveloped virus according to any one of [1] to [4] above.
[6] A coating composition including the antiviral agent against a non-enveloped virus according to any one of [1] to [4] above and an adhesive resin.
[7] A production method of an antiviral product, including:

a step in which the coating composition according to [6] above and a base material are used to form a coat on a surface of the base material, and

a step in which the coat is dried.

### ADVANTAGEOUS EFFECTS OF INVENTION

The antiviral agent against a non-enveloped virus, the composition containing thereof, and the antiviral product in embodiments according to the present invention are suitable for inactivating a non-enveloped virus.

### DESCRIPTION OF EMBODIMENT

The antiviral agent against a non-enveloped virus of an embodiment according to the present invention includes at least one selected from a group consisting of (A) a compound containing Al element, Mg element, and O element; (B) a compound containing an alkali metal element or an alkaline earth metal element, Si element, and O element; and (C) a hydroxide containing a divalent metal element. The hydroxide (C) is a compound that does not contain a trivalent metal element and Si element.

The antiviral agent against a non-enveloped virus in the embodiment according to the present invention may be one type of the compound (A), the compound (B), and the hydroxide (C), a combination of two types among these compounds, or a combination of three types.

Examples of the virus inactivated by the antiviral agent against a non-enveloped virus of the embodiment according to the present invention include norovirus, adenovirus, rotavirus, human papillomavirus, poliovirus, enterovirus, coxsackievirus, human parvovirus, encephalomyocarditis virus, poliovirus, rhinovirus, and the like.

The compound (A) is a compound containing Al element, Mg element, and O element. This compound may be an oxide; a hydroxide; an inorganic acid salt such as a nitrate, a sulfate, and a phosphate; an organic acid salt such as an acetate; and a complex. Among these, an oxide and a hydroxide are preferable, and the oxide is particularly preferable.

Examples of the oxide include a compound represented by the following general formula (1).

MgₓAl_{y}O_{(x+1.5y)} (1)

(In the formula, x and y are integers.)

In the general formula (1), a relationship between x and y is preferably x>y.

Examples of the hydroxide include a compound represented by the following general formula (2).

[M²⁺₁₋ₚM³⁺ₚ(OH)₂]^{q+}[Aⁿ⁻_{p/n}·mH₂O]^{q-} (2)

(In the formula, M²⁺ is a divalent metal ion, M³⁺ is a trivalent metal ion, Aⁿ⁻_{p/n} is an interlayer anion, 0<p≤0.33 is satisfied, n is a valence number of A, and 0≤m<1 is satisfied.)

In the general formula (2), examples of M²⁺ include Mg²⁺ ion, Ca²⁺ ion, Ba²⁺ ion, and the like. Examples of M³⁺ include Fe³⁺ ion, Al³⁺ ion, La³⁺ ion, and the like.

The compound represented by the general formula (2) is preferably a compound in which M²⁺ is an Mg²⁺ ion and M³⁺ is an Al³⁺ ion.

The compound (B) is a compound containing an alkali metal element or an alkaline earth metal element, Si element, and O element. Examples of the alkali metal element include Li element, Na element, K element, Rb element, Cs element, Fr element, and the like. Among these, Na element is preferable.

The compound (B) is preferably a silicate, and more preferably a sodium silicate. Compounds represented by Na₂SiO₃, Na₄SiO₄, Na₂Si₂O₅, or Na₂Si₄O₉ are known as the sodium silicate, and Na₂Si₂O₅ is preferable among these.

The hydroxide (C) is a compound containing a divalent metal element. Examples of the divalent metal element include Group 2 elements in the periodic table (such as Be element, Ca element, Sr element, Ba element and Ra element), Cu element, Ni element, Co element, Zn element, Ge element, and the like. Among these, the alkaline earth metal element is preferable, and Ca element is particularly preferable.

The hydroxide (C) is preferably calcium hydroxide.

Although the antiviral agent against a non-enveloped virus of the embodiment according to the present invention may be used without changing its properties, the antiviral agent against a non-enveloped virus can be applied to a liquid agent (aerosol) prepared by dispersing the antiviral agent against a non-enveloped virus in a medium, and a coating composition to bond the antiviral agent against a non-enveloped virus by applying and drying the antiviral agent against a non-enveloped virus on a surface of a base material having a predetermined shape. A complex in which the antiviral agent against a non-enveloped virus is impregnated to the surface of the base material is an example of an antiviral product described later.

The antiviral agent against a non-enveloped virus of the embodiment according to the present invention may also be applied to a resin composition for molding process contained together with a resin or a precursor thereof When a molding process for forming a predetermined shape is performed after that, a molded product containing the antiviral agent against a non-enveloped virus can be obtained. Such a molded product is an example of the antiviral product described later.

When the antiviral agent against a non-enveloped virus of the embodiment according to the present invention is applied to, as described above, a coating composition or a resin composition, the antiviral agent against a non-enveloped virus is preferably having a small particle size. The upper limit of the particle size is preferably 30 μm, and more preferably 10 μm. The lower limit thereof is preferably 50 nm, and more preferably 100 nm. The shape of the particle is not particularly limited.

The coating composition of the embodiment according to the present invention includes the antiviral agent against a non-enveloped virus and an adhesive resin. A medium of the coating composition may be water, an organic solvent, or a mixture thereof, but is preferably water or a mixture of water and a water-soluble organic solvent.

The adhesive resin contained in the coating composition of the embodiment according to the present invention may be singly or in combination of two or more types thereof.

The adhesive resin is appropriately selected depending on types of the medium. In a case where the medium is water or a mixture of water and a water-soluble organic solvent, the adhesive resin may be either a water-soluble resin or a water-insoluble resin.

Examples of the adhesive resin include an acrylic resin, an ethylene vinyl acetate copolymer or a modified polymer thereof (such as acid-modified polymer), an ethylene/vinyl chloride copolymer, a vinyl chloride/vinyl acetate copolymer, polyvinyl acetate, polyvinyl chloride, a modified olefin resin (such as chlorinated polyolefin), a polyester resin, a urethane resin, a styrene/butadiene copolymer, a styrene/isoprene copolymer, a styrene/butadiene/styrene block copolymer, a styrene/ethylene▪butylene/styrene block copolymer, a styrene/ethylene▪propylene/styrene block copolymer, a hydrogenated styrene/butadiene/styrene block copolymer, a hydrogenated styrene/ethylene▪butylene/styrene block copolymer, a hydrogenated styrene/ethylene▪propylene/styrene block copolymer, and the like. Among these, an acrylic resin is preferable.

A content ratio of the adhesive resin contained in the coating composition of the embodiment according to the present invention is preferably in a range from 10 to 200 parts by mass, more preferably from 10 to 15 parts by mass, and further preferably from 20 to 100 parts by mass based on 100 parts by mass of the antiviral agent against a non-enveloped virus.

The coating composition of the embodiment according to the present invention may include additives such as a dispersant, a viscosity modifier, an antifoaming agent, a colorant, a fragrance, and a preservative.

A content ratio of the antiviral agent against a non-enveloped virus included in the coating composition of the embodiment according to the present invention is preferably in a range from 0.5% to 50% by mass, more preferably from 1% to 40% by mass, and further preferably from 1% to 30% by mass from a viewpoint of efficient inactivation of a non-enveloped virus in the antiviral product to be obtained.

A method for producing an antiviral product in which the antiviral agent against a non-enveloped virus is impregnated to a surface of a base material using the coating composition of the embodiment according to the present invention will be described.

A method for producing such an antiviral product includes a step of applying a coating composition to a base material to form a coat (hereinafter, referred to as “coating step”) and a step of drying the coat formed (hereinafter, referred to as “drying step”).

The base material is not particularly limited, and may be an article containing an inorganic material, an organic material, or a material combining these materials. The shape thereof is not particularly limited. Examples of the base material include resin molded products including foamed resin molded products such as films, granules, and general molded products; fibers; fiber products such as non-woven fabrics and woven fabrics containing fibers; and the like.

In the coating step, padding, dipping, coating, spraying, printing, and the like can be applied. In the coating step, single-layer coating or multi-layer coating may be performed depending on the shape of the base material and the like.

In the drying step, closed heating, warm air heating, or the like is applied depending on the shape of the base material and the like, and a medium is removed from the coat to form a film containing the antiviral agent against a non-enveloped virus. This makes it possible to obtain an antiviral product having the film on the surface of the base material.

The antiviral product against a non-enveloped virus of the embodiment according to the present invention is a product including at least one selected from a group consisting of the compounds (A), (B) and (C).

As described above, those obtained using the coating composition and molded products obtained by subjecting a resin composition including the antiviral agent against a non-enveloped virus and a resin or its precursor to publicly known molding processing methods are preferable examples of the antiviral product against a non-enveloped virus. The latter resin composition may be either a thermoplastic resin composition or a curable resin composition. When a part of the antiviral agent against a non-enveloped virus is exposed in the obtained resin molded product, an inactivating effect of the non-enveloped virus is excellent.

The present invention is useful in the fields of industry, cleaning, medicine, food and the like. Specific examples of the antiviral product against a non-enveloped virus include films (such as wrapping film, decorative film, packaging bag, and the like), papers (such as wallpaper, seal paper, and the like), filters (such as air purifier filter, air conditioner filter, and the like), masks, gloves, stationery, tableware, cooking utensils, trays, shelves, doors, fences, handrails, desks, chairs, sofas, brushes, clothing, sports goods, hanging straps, housings for electrical products, and the like.

### EXAMPLES

Hereinafter, embodiments of the present invention will be described in more detail with reference to Examples, but the present invention is not limited to these Examples.

### 1. Antiviral Agent Against a Non-Enveloped Virus

Antiviral agents V1 to V6 consisting of the following components were used.

### (1) V1

A powder of calcined hydrotalcite (composite oxide represented by chemical formula: Mg₇Al₃O_{11.5}), having a particle size of 0.1 to 30 μm by laser diffraction type particle size distribution meter.

### (2) V2

A powder of sodium silicate (silicate represented by chemical formula: Na₂Si₂O₅), having a particle size of 0.1 to 30 μm by laser diffraction type particle size distribution meter.

### (3) V3

A powder of calcium hydroxide, having a particle size of 0.1 to 30 μm by laser diffraction type particle size distribution meter.

### (4) V4

A mica powder having a particle size of 0.1 to 30 μm by laser diffraction type particle size distribution meter.

### (5) V5

A powder of MFI type zeolite (Na type), having a particle size of 0.1 to 30 μm by laser diffraction type particle size distribution meter.

### (6) V6

A powder of MFI type zeolite (H type), having a particle size of 0.1 to 30 μm by laser diffraction type particle size distribution meter.

### 2. Evaluation of Antiviral Agent Against a Non-Enveloped Virus

### Examples 1 to 3 and Comparative Examples 1 to 3

The performance of each of the above antiviral agents was evaluated by applying methods shown in JIS L 1922 (antiviral property test method of fiber product), and an antiviral activity value (Mv) obtained was used to determine the antiviral property. According to JIS L 1922, it is classified that the effect is exhibited in a case of 3>Mv≥2.0, and a sufficient effect is exhibited in a case of Mv≥3.0.

Purified water was added to the antiviral agent so that its concentration was 0.1% by mass. Next, 100 μL of feline calicivirus solution having a virus infectivity of 1 to 5×10⁷ PFU/mL was added to 900 μL of the above liquid, and a mixed liquid was allowed to stand at a temperature of 25° C. for 2 hours. Thereafter, the mixed liquid was recovered, and the recovered liquid was subjected to a plaque count measurement method to measure the virus infectivity. The virus infectivity was measured in the same manner as the test sample except that 900 μL of phosphate buffered saline (PBS) was used as a control sample instead of the test sample.

The performance of the antiviral agent was evaluated by the antiviral activity value (Mv) obtained by the following formula. The results are shown in Table 1.

Mv=Log (virus infectivity of control sample)−Log (virus infectivity of test sample)

TABLE 1

| | | Antiviral |
|---|---|---|
| | | activity |
| | Antiviral agent | value Mv |
| Example 1 | V1: Calcined hydrotalcite | 2.5 |
| Example 2 | V2: Sodium silicate | 3.2 |
| Example 3 | V3: Calcium hydroxide | 4.2 |
| Comparative example 1 | V4: Mica | 0.4 |
| Comparative example 2 | V5: MFI type zeolite (Na type) | 0.3 |
| Comparative example 3 | V6: MFI type zeolite (H type) | 0.3 |

As is clear from results in Table 1, Examples 1, 2, and 3 using the antiviral agents V1, V2 and V3 showed excellent antiviral properties.

### 3. Production of Antiviral Product Against a Non-Enveloped Virus

### Example 4

The antiviral agent V1 and a binder containing an acrylic resin as an adhesive resin and water as a medium are mixed so that a mass ratio of the antiviral agent and the adhesive resin was 1:1 to prepare a coating composition. Subsequently, a polyester fabric having a basis weight of 25 g/m² was dipped in this coating composition. After that, the coated fabric was dried at a temperature of 130° C. to produce an antiviral processed fabric in which an impregnation amount of the antiviral agent V1 was 3 g/m².

### Example 5

An antiviral processed fabric was produced in the same manner as those in Example 4 except that the antiviral agent V2 was used instead of the antiviral agent V1.

### Example 6

An antiviral processed fabric was produced in the same manner as those in Example 4 except that the antiviral agent V3 was used instead of the antiviral agent V1.

### INDUSTRIAL APPLICABILITY

In the present invention, the antiviral agent against a non-enveloped virus and the antiviral product against a non-enveloped virus containing the antiviral agent against a non-enveloped virus are suitable for inactivating the non-enveloped virus such as norovirus, and are useful in the fields of industry, cleaning, medicine, food and the like.

The antiviral agent against a non-enveloped virus not only can be used as a raw material for producing the antiviral product against a non-enveloped virus, but also can inactivate a virus already attached to an article by being brought into contact with the virus.

1. An antiviral agent against a non-enveloped virus, comprising at least one selected from the group consisting of:
(A) a compound comprising Al, Mg, and O;
(B) a compound comprising an alkali metal or an alkaline earth metal element, Si, and O; and
(C) a hydroxide comprising a divalent metal.

2. The antiviral agent against a non-enveloped virus according to claim 1, wherein the compound (A) is a compound represented by the following formula (1).
MgₓAl_{y}O_{(x+1.5y)} (1)
(wherein, in formula (1), x and y are integers.

3. The antiviral agent against a non-enveloped virus according to claim 1, wherein the compound (B) is a silicate.

4. The antiviral agent against a non-enveloped virus according to claim 1, wherein the hydroxide (C) is a compound comprising an alkaline earth metal.

5. An antiviral product comprising the antiviral agent against a non-enveloped virus according to claim 1.

6. A coating composition comprising the antiviral agent against a non-enveloped virus according to claim 1 and an adhesive resin.

7. A method of producing an antiviral product, comprising:
forming a coat on a surface of a base material with the coating composition according to claim 6, and
drying the coat.
